(19) United States
(12) Patent Application Publication
(10) Pub. No.: US 2025/0109006 A1
(43) Pub. Date: Apr. 3, 2025

(54) COOLING DEVICE, WATER PURIFIER HAVING COOLING DEVICE AND MANUFACTURING METHOD THEREFOR

(71) Applicant: SAMSUNG ELECTRONICS CO., LTD., Suwon-si (KR)

(72) Inventors: Doyun JANG, Suwon-si (KR); Seokuk KIM, Suwon-si (KR); Seonjeong LEE, Suwon-si (KR); Junggeun LEE, Suwon-si (KR)

(73) Assignee: SAMSUNG ELECTRONICS CO., LTD., Suwon-si (KR)

(21) Appl. No.: 18/980,095

(22) Filed: Dec. 13, 2024

Related U.S. Application Data
(63) Continuation of application No. PCT/KR2023/010499, filed on Jul. 20, 2023.

(30) Foreign Application Priority Data
Jul. 28, 2022 (KR) 10-2022-0094215

(51) Int. Cl. B67D 1/08

(52) U.S. Cl. CPC B67D 1/0859; B67D 1/0884; B67D 2210/00026; B67D 2210/00044

(57) ABSTRACT

A cooling device including a water tank case, an evaporator at least a portion of which is accommodated in the water tank case to exchange heat with cooling water stored inside the water tank case, a water tank case insulating portion foam-molded to surround an outer surface of the water tank case, a water tank cover having at least one component disposed thereon and disposed on the upper side of the water tank case, a water tank cover insulating portion foam-molded to form a water tank insulating portion seamlessly integrated with the water tank case insulating portion and surrounding an outer surface of the water tank cover, and a sealing member around the at least one component disposed on the water tank cover to prevent a gap leading to the water tank case from being formed.

### CROSS-REFERENCE TO RELATED APPLICATIONS

This application is a continuation of International Application PCT/KR2023/010499, filed Jul. 20, 2023, and claims foreign priority to Korean Application 10-2022-0094215, filed Jul. 28, 2022, and which are incorporated herein by reference in their entireties.

### BACKGROUND

### Filed

Various embodiments of the disclosure relate to a water purifier including a cooling device.

### DESCRIPTION OF RELATED ART

A water purifier is a device that physically or chemically filters raw water or impurities such as foreign substances or heavy metals contained in the water supply and then provides the filtered water to the user. The water purifier may provide the filtered water to the user as purified water at room temperature, as cold water at a temperature lower than room temperature, and/or as hot water at a temperature higher than room temperature. To that end, the water purifier may include a heating device for generating hot water and/or a cooling device for generating cold water.

The cooling device of the water purifier may generate and supply cold water using, e.g., a tank cooling method in which water (e.g., purified water) accommodated in a water tank is directly cooled by an evaporator disposed in the water tank. The cooling device of the water purifier may use, as another example, an ice storage cooling method in which water (e.g., an ice storage liquid) accommodated in a water tank (e.g., an ice storage tank) is cooled by an evaporator disposed in the water tank, and purified water flowing through a separate cold water pipe is cooled through heat exchange using the cooled water (e.g., an ice storage liquid). The water purifier may include a cooling cycle device including a compressor, a condenser, an expansion valve, or an evaporator.

### SUMMARY

A cooling device of a water purifier may typically include an evaporator, a lower water tank case for accommodating cooling water, and an upper water tank cover providing a water inlet/outlet path to/from the water tank case and having, e.g., a stirrer used to make the temperature in the water tank case uniform. The cooling device of the water purifier may typically include a water tank case and an insulation cover surrounding the outer circumferential surface of the water tank cover and forming the exterior of the cooling device so as to maintain the cooling state.

A cooling device for a water purifier according to an embodiment of the disclosure may include a water tank case to accommodate cooling water therein, an evaporator at least partially accommodated in the water tank case to exchange heat with the cooling water accommodated in the water tank case, a water tank cover having at least one component disposed thereon and disposed above the water tank case, a water tank cover insulator and a water tank case insulator that are both made of a foamed material and together form an integral insulator without a seam between the water tank cover insulator and the water tank case insulator, wherein the water tank case insulator surrounds an outer circumferential surface of the water tank case, and the water tank cover insulator surrounds an outer circumferential surface of the water tank cover, and a sealing member disposed to prevent a gap leading to the water tank case from being formed, around the at least one component disposed on the water tank cover.

According to an embodiment, the cooling device may further include a cold water pipe at least partially accommodated in the water tank case, and having an inside where water for heat exchange with the cooling water accommodated in the water tank case flows. The at least one component disposed on the water tank cover may include a portion of the cold water pipe passing through the water tank cover and communicating with an outside of the cooling device. The sealing member may include a cold water pipe sealing member disposed not to form the gap leading to the water tank case around the portion of the cold water pipe.

According to an embodiment, the water tank cover may include a pair of communication pipes having a hollow shape extending upward from an upper surface of the water tank cover. The cold water pipe may pass through each of the pair of communication pipes. The cold water pipe sealing member may seal a space between each communication pipe and a cold water pipe passing through a corresponding communication pipe.

According to an embodiment, the at least one component disposed on the water tank cover may include a stirring motor to stir the cooling water accommodated in the water tank case. The sealing member may include a motor sealing member disposed not to form a gap leading to the water tank case around the stirring motor.

According to an embodiment, the water tank cover may include a motor recess recessed downward from an upper surface of the water tank cover. The motor sealing member may be disposed in the motor recess.

According to an embodiment, the cooling device may further include a heater disposed on a surface of the water tank cover insulator or the water tank case insulator to prevent dew formation on a surface of the cooling device. The water tank cover insulator or the water tank case insulator may include a heater guide in which at least a portion of a surface thereof is recessed to allow the heat to be seated therein.

According to an embodiment, the at least one component disposed on the water tank cover may include a temperature sensor for measuring a temperature inside the water tank case. A fastening plate and a screw fastening structure for sealing the temperature sensor may be disposed above the temperature sensor.

A method according to an embodiment of the disclosure may include foaming a water tank case insulator surrounding an outer circumferential surface of a water tank case configured to accommodate cooling water, disposing one or more structure for supplying cold water into the water tank case, disposing a sealing member at at least one position on a water tank cover configured to cover an upper portion of the water tank case, disposing a component corresponding to the at least one position of the water tank cover, disposing the water tank cover to cover an upper side of the water tank case, and integrally foaming an insulator to surround the water tank case and the water tank cover disposed on the upper side of the water tank case.

According to an embodiment, the one or more structures for supplying the cold water, disposed in the water tank case may include an evaporator and a cold water pipe where water cooled by heat exchange with the evaporator flows. Disposing the component corresponding to the at least one position of the water tank cover may include disposing to allow a portion of the cold water pipe to pass through the water tank cover and communicate with an outside of the water tank case. Disposing the sealing member may include disposing a cold water pipe sealing member around the portion of the cold water pipe.

According to an embodiment, the water tank cover may include a pair of communication pipes having a hollow shape extending upward from an upper surface of the water tank cover. Disposing to allow the portion of the cold water pipe to pass through the water tank cover and communicate with the outside of the water tank case may include disposing the cold water pipe to pass through each of the pair of communication pipes. Disposing the cold water pipe sealing member may include disposing the cold water pipe sealing member to seal a space between each communication pipe and a cold water pipe passing through a cooling device communication pipe.

According to an embodiment, disposing the component corresponding to the at least one position of the water tank cover may include disposing a stirring motor stirring the cooling water accommodated in the water tank case. Disposing the sealing member may include disposing a motor sealing member around the stirring motor.

According to an embodiment, the water tank cover may include a motor recess recessed downward from an upper surface. The motor sealing member may be disposed in the motor recess.

According to an embodiment, disposing the component corresponding to the at least one position of the water tank cover may include disposing a temperature sensor. Disposing the sealing member may include disposing a fastening plate and a screw fastening structure for sealing the temperature sensor, above the temperature sensor.

According to an embodiment, integrally foaming the insulator to surround the water tank case and the water tank cover may include foaming the insulator to form a recess for disposing a heating cable in an outer circumferential surface of the insulator.

A water purifier according to an embodiment of the disclosure may include a filter unit to generate purified water by filtering raw water and a cooling device to generate cold water by cooling the purified water generated by the filter unit. The cooling device may include a water tank case to accommodate cooling water therein, an evaporator at least partially accommodated in the water tank case to exchange heat with the cooling water accommodated in the water tank case, a water tank cover having at least one component disposed thereon and disposed above the water tank case, a water tank cover insulator and a water tank case insulator that are both made of a foamed material and together form an integral insulator without a seam between the water tank cover and the water tank case insulator, wherein the water tank case insulator surrounds an outer circumferential surface of the water tank case, and the water tank cover insulator surrounds an outer circumferential surface of the water tank cover, and a sealing member disposed to prevent a gap leading to the water tank case from being formed, around the at least one component disposed on the water tank cover.

According to various embodiments of the disclosure, as the water tank cover insulator is foamed integrally with the water tank case insulator, no seam or gap is formed between the lower water tank case insulator and the upper water tank cover insulator of the cooling device, thus preventing cold air leakage to the outside and increasing the cooling efficiency of the cooling device. Further, a separate sealing member, e.g., OPP tape, overall surrounding the seam between the water tank case insulator and the water tank cover insulator to prevent cold air leakage is not required, reducing manufacturing costs required for forming the insulator and simplifying the process.

Effects achievable in example embodiments of the disclosure are not limited to the above-mentioned effects, but other effects not mentioned may be apparently derived and understood by one of ordinary skill in the art to which example embodiments of the disclosure pertain, from the following description. In other words, unintended effects in practicing embodiments of the disclosure may also be derived by one of ordinary skill in the art from example embodiments of the disclosure.

### BRIEF DESCRIPTION OF THE DRAWINGS

FIG. 1 is a perspective view illustrating a water purifier according to an embodiment of the disclosure;

FIG. 2 is a perspective view illustrating a water purifier according to an embodiment of the disclosure;

FIG. 3 is a view illustrating an inside of a water purifier according to an embodiment of the disclosure;

FIG. 4 is a perspective view illustrating a cooling device according to an embodiment of the disclosure, shown in FIG. 3;

FIG. 5 is a cross-sectional view illustrating a cooling device according to an embodiment of the disclosure, taken along line A-A of FIG. 4;

FIG. 6 is a perspective view illustrating a cooling device according to an embodiment of the disclosure, showing a state when a water tank cover insulator is foamed;

FIG. 7 is a plan view illustrating a cooling device according to an embodiment of the disclosure, showing a state when a water tank cover insulator is foamed;

FIG. 8 is a cross-sectional view illustrating a cooling device according to an embodiment of the disclosure, taken along line B-B of FIG. 7;

FIG. 9 is a flowchart illustrating assembly of a cooling device according to an embodiment of the disclosure; and

FIGS. 10A to 10I are views illustrating an order of assembly of a cooling device according to an embodiment of the disclosure.

### DETAILED DESCRIPTION

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

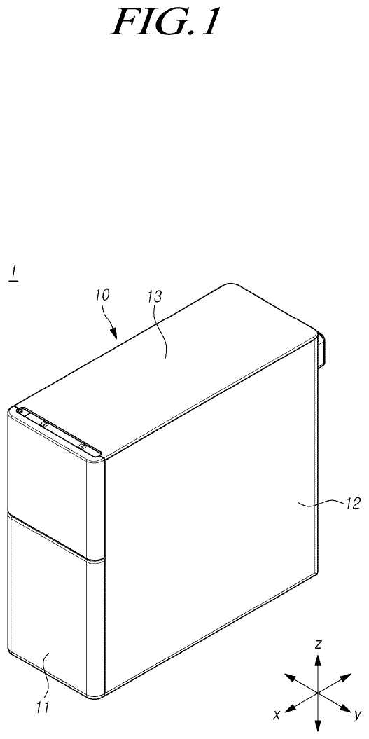

FIG. 1 is a front perspective view illustrating a water purifier according to an embodiment of the disclosure.

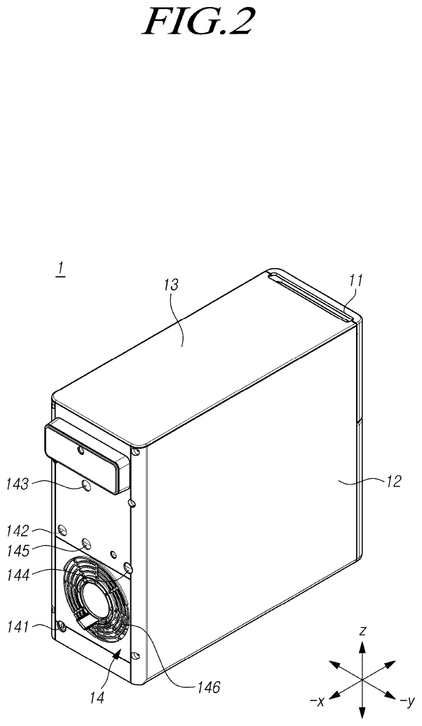

FIG. 2 is a rear perspective view illustrating a water purifier according to an embodiment of the disclosure.

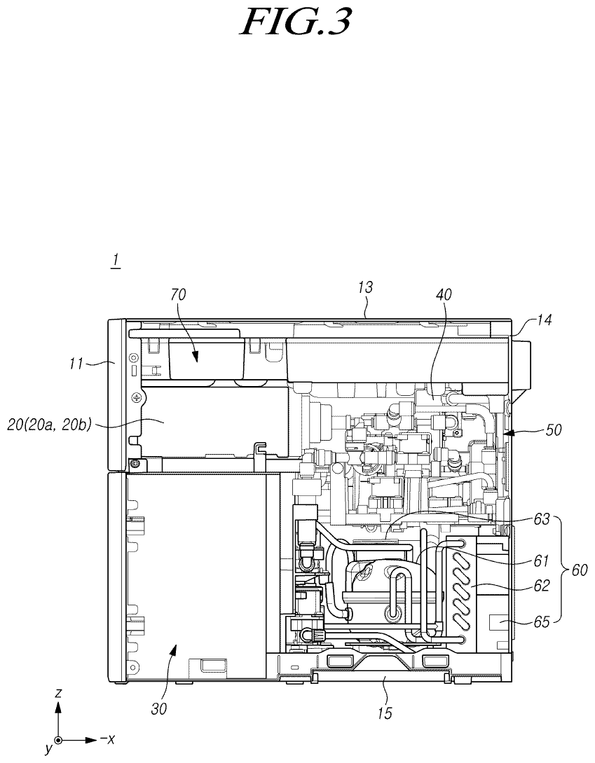

FIG. 3 is a view illustrating an inside of a water purifier according to an embodiment of the disclosure.

Referring to FIGS. 1 to 3, in an embodiment, a water purifier 1 may include a case 10, a filter unit 20, a cooling device 30, a heating device 40, a valve assembly 50, a cooling cycle device 60, and a controller 70.

According to an embodiment, the case 10 may form the overall appearance of the water purifier 1. According to an embodiment, the case 10 may be formed in a rectangular parallelepiped shape as a whole, but the disclosure is not limited thereto. According to an embodiment, the case 10 may include a front panel 11, a side panel 12, an upper panel 13, a rear panel 14, and a base 15.

According to an embodiment, the front panel 11 may form a front side of the water purifier 1. According to an embodiment, the side panel 12 may form a side surface of the water purifier 1. According to an embodiment, the upper panel 13 may form an upper side of the water purifier 1. According to an embodiment, the rear panel 14 may form a rear side of the water purifier 1.

According to an embodiment, the rear panel 14 may include a raw water inlet 141, a cold water/purified water outlet 142, a hot water outlet 143, a drain inlet 144, or a drain outlet 145. According to an embodiment, each of the raw water inlet 141, the cold water/purified water outlet 142, the hot water outlet 143, the drain inlet 144, or the drain outlet 145 may be connected to the valve assembly 50.

According to an embodiment, raw water (e.g., water) in a room temperature state may be supplied into the water purifier 1 through the raw water inlet 141. For example, raw water from a water source such as a waterworks (or water supply) (not shown) may be supplied into the water purifier 1 through the raw water inlet 141.

According to an embodiment, purified water or cold water filtered by the water purifier 1 may be supplied to the outside through the cold water/purified water outlet 142. For example, cold water or purified water supplied from the water purifier 1 to the outside through the cold water/purified water outlet 142 may be supplied to a water supply device such as a faucet (not shown) and provided to the user. In the drawings, it is illustrated that cold water and purified water from the water purifier 1 are supplied through the cold water/purified water outlet 142, but the disclosure is not limited thereto. In an embodiment, a cold water outlet and a purified water outlet for each of cold water and purified water may be separately formed in the rear panel 14.

According to an embodiment, hot water filtered and heated by the water purifier 1 may be supplied to the outside through the hot water outlet 143. For example, hot water supplied from the water purifier 1 through the hot water outlet 143 may be supplied to a water supply device such as a faucet (not shown) and provided to the user.

According to an embodiment, water (e.g., residual water) discarded from the water supply device such as a faucet (not shown) may flow into the water purifier 1 through the drain inlet 144. In this case, through the drain outlet 145, water discarded from the water supply device may be discharged to the outside together with water (e.g., residual water) remaining in the valve assembly 50 inside the water purifier 1 and a pipe (not shown) connecting each of the filter unit 20, the cooling device 30, or the heating device 40.

According to an embodiment, the rear panel 14 may include an exhaust hole 146. According to an embodiment, the exhaust hole 146 may discharge heat inside the water purifier 1 to the outside. According to an embodiment, the exhaust hole 146 may be provided as a circular grill as a whole, but the disclosure is not limited thereto.

According to an embodiment, the base 15 may form a bottom side of the water purifier 1. According to an embodiment, the base 15 may be provided to support some (e.g., the cooling device 30 or the cooling cycle device 60) of components disposed inside the water purifier 1.

According to an embodiment, the filter unit 20 may be connected to the valve assembly 50. According to an embodiment, the filter unit 20 may receive the raw water introduced through the raw water inlet 141 through the valve assembly 50, and filter foreign substances contained in the supplied raw water and impurities such as heavy metals. According to an embodiment, the filter unit 20 may be disposed above the cooling device 30, but the disclosure is not limited thereto. According to an embodiment, the filter unit 20 may supply water (hereinafter, purified water) in a room temperature state filtered by the filter unit 20 to at least one of the cooling device 30, the heating device 40, or the cold water/purified water outlet 142 to be described below through the valve assembly 50.

The filter unit 20 may include at least one filter (e.g., a membrane filter and a post-processing filter). According to an embodiment, the filter unit 20 may include a first filter 20a and a second filter 20b. According to an embodiment, the first filter 20a and the second filter 20b may be arranged side by side in the horizontal direction, but are not limited thereto. According to an embodiment, the first filter 20a and the second filter 20b each may be disposed vertically.

According to an embodiment, the first filter 20a and the second filter 20b may be connected in series with each other. For example, raw water supplied from the water source to the first filter 20a through the raw water inlet 141 and the valve assembly 50 may be first filtered by the first filter 20a. Thereafter, the water filtered by the first filter 20a may be supplied again to the second filter 20b to be second filtered by the second filter 20b. According to an embodiment, the first filter 20a and the second filter 20b may be connected in parallel. For example, raw water may be supplied to each of the first filter 20a and the second filter 20b, and raw water may be filtered by each of the first filter 20a and the second filter 20b.

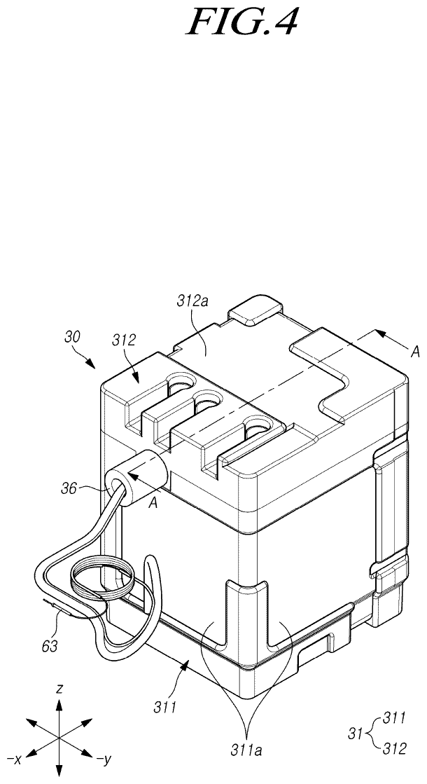

According to an embodiment, the cooling device 30 may be connected to the valve assembly 50. According to an embodiment, the cooling device 30 may receive water (e.g., purified water) in a room temperature state filtered by the filter unit 20 through the valve assembly 50. According to an embodiment, the cooling device 30 may cool the supplied water in the room temperature state. According to an embodiment, the cooling device 30 may provide water (cold water) cooled by the cooling device 30 to the user through the valve assembly 50 and the cold water/purified water outlet 142. The specific structure of the cooling device 30 is described below with reference to FIG. 4 and its subsequent drawings.

According to an embodiment, the heating device 40 may be disposed adjacent to at least a portion of the valve assembly 50. For example, the heating device 40 may be disposed in parallel with at least a portion of the valve assembly 50. According to an embodiment, the heating device 40 may be connected to the valve assembly 50. According to an embodiment, the heating device 40 may heat the water supplied to the heating device 40 through the valve assembly 50 after being filtered by the filter unit 20 and provide the heated hot water to the user through the valve assembly 50 and the hot water outlet 143.

According to an embodiment, as described above, the valve assembly 50 may be connected to each of the raw water inlet 141 of the rear panel 14, the cold water/purified water outlet 142, and the hot water outlet 143, the filter unit 20, the cooling device 30, and the heating device 40. According to an embodiment, the valve assembly 50 may include at least one pipe, valve, or pump for transferring or supplying water (e.g., purified water, cold water, or hot water) between the raw water inlet 141, the cold water/purified water outlet 142, the hot water outlet 143, the filter unit 20, the cooling device 30, or the heating device 40.

According to an embodiment, as described above, the valve assembly 50 may supply raw water from the raw water inlet 141 to the filter unit 20. According to an embodiment, as described above, the valve assembly 50 may supply water (e.g., purified water) in the room temperature state filtered by the filter unit 20 to any one of the cooling device 30, the heating device 40, or the cold water/purified water outlet 142.

According to an embodiment, the cooling cycle device 60 may circulate the refrigerant through the cooling device 30 and may cool purified water supplied from the filter unit 20 to the cooling device 30 through heat exchange with the circulating refrigerant. According to an embodiment, the cooling cycle device 60 may be disposed on the base 15 in the case 10.

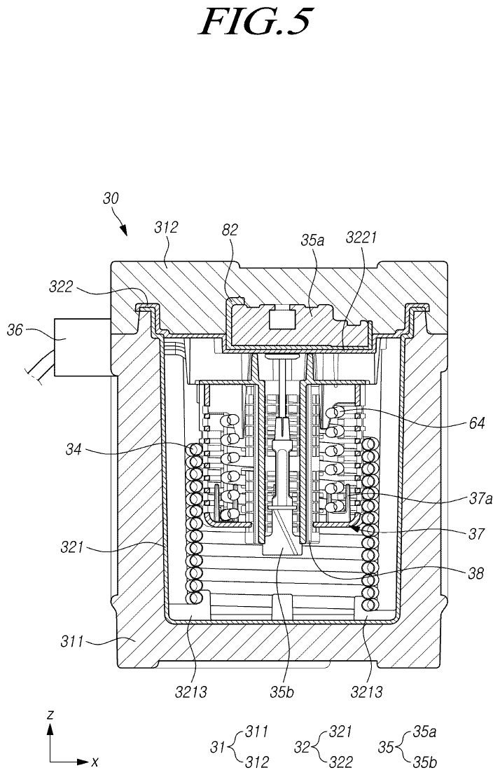

According to an embodiment, the cooling cycle device 60 may include a compressor 61, a condenser 62, an expander 63, and an evaporator 64. According to an embodiment, the cooling cycle device 60 may form a cooling cycle in which the refrigerant circulates through the compressor 61, the condenser 62, the expander 63, and the evaporator (e.g., the evaporator 64 of FIG. 5).

According to an embodiment, the compressor 61 may compress the refrigerant into a high-temperature, high-pressure gaseous state. According to an embodiment, the compressor 61 may compress the refrigerant and discharge the compressed refrigerant to the condenser 62.

According to an embodiment, the condenser 62 may condense the refrigerant. According to an embodiment, the condenser 62 may discharge heat of the refrigerant to the air through heat exchange between the refrigerant compressed by the compressor 61 and the air. According to an embodiment, the condenser 62 may discharge the condensed refrigerant to the expander 63.

According to an embodiment, the expander 63 may expand the refrigerant. According to an embodiment, the expander 63 may be connected between the condenser 62 and the evaporator 64. According to an embodiment, the expander 63 may drop the pressure or temperature of the condensed refrigerant discharged from the condenser 62. According to an embodiment, the expander 63 may discharge the expanded refrigerant to the evaporator 64. According to an embodiment, the expander 63 may be formed of a capillary tube, but is not limited thereto. According to an embodiment, the expander 63 may be configured as an expansion valve.

According to an embodiment, the evaporator 64 may evaporate the refrigerant. According to an embodiment, at least a portion of the evaporator 64 may be accommodated in the cooling device 30. According to an embodiment, in the evaporator 64, the purified water supplied from the filter unit 20 to the cooling device 30 may be cooled through heat exchange between the refrigerant discharged from the expander 63 and the ice storage liquid accommodated in the cooling device 30, which is described below. The detailed structure of the evaporator 64 is described below with reference to FIG. 5.

According to an embodiment, the cooling cycle device 60 may further include a fan 65. According to an embodiment, the fan 65 may be disposed adjacent to the condenser 62. According to an embodiment, the fan 65 may rotate to promote heat dissipation of the refrigerant flowing in the condenser 62. According to an embodiment, the fan 65 may rotate to discharge heat inside the water purifier 1 to the outside. According to an embodiment, the fan 65 may prevent overheating of components disposed inside the water purifier 1, such as the cooling cycle device 60.

According to an embodiment, the controller 70 may control the overall operation of the components (e.g., the valve assembly 50, the compressor 61, and the fan 65) included in the water purifier 1. According to an embodiment, the controller 70 may include components such as a printed circuit board (PCB) on which electrical elements are disposed. According to an embodiment, the controller 70 may be electrically connected to components (e.g., the valve assembly 50, the compressor 61, and the fan 65) included in the water purifier 1. According to an embodiment, the controller 70 may control the valve assembly 50 to change the flow path of the water so that the water filtered by the filter unit 20 may be appropriately supplied to the cooling device 30, the heating device 40, or the cold water/purified water outlet 142. According to an embodiment, the controller 70 may control the valve assembly 50 to properly supply cold water or hot water from the cooling device 30 or the heating device 40 to the cold water/purified water outlet 142 or the hot water outlet 143. According to an embodiment, the controller 70 may be positioned on the rear surface of the upper panel 13 inside the case 10, but the disclosure is not limited thereto.

FIG. 4 is a perspective view illustrating the cooling device shown in FIG. 3 according to an embodiment.

FIG. 5 is a cross-sectional view of the cooling device, taken along line A-A of FIG. 4.

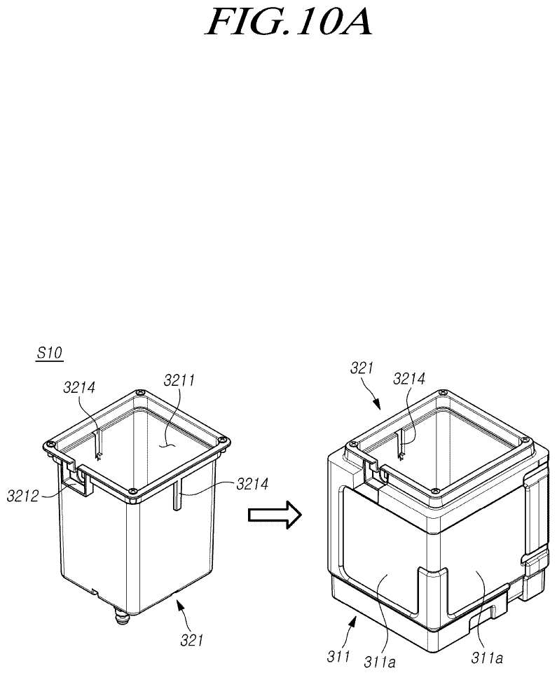

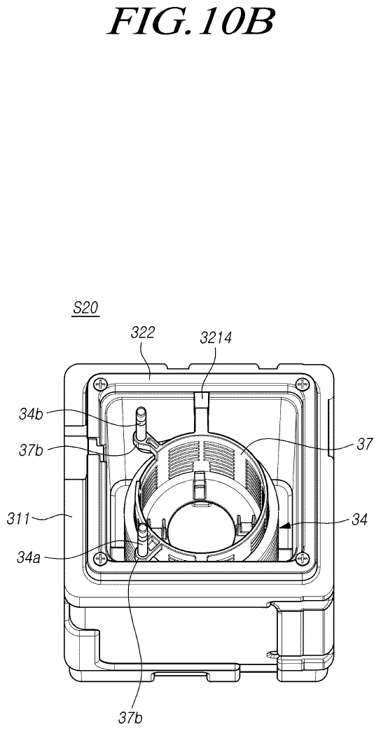

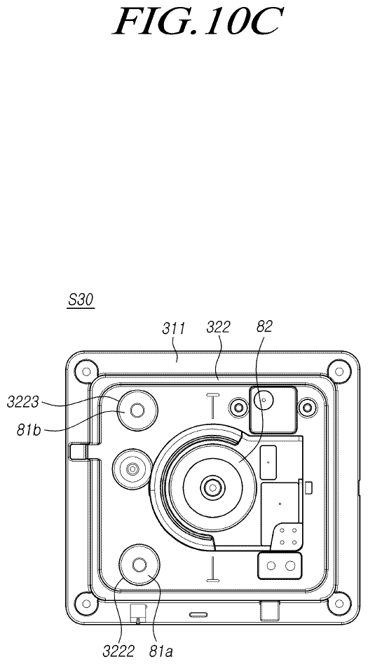

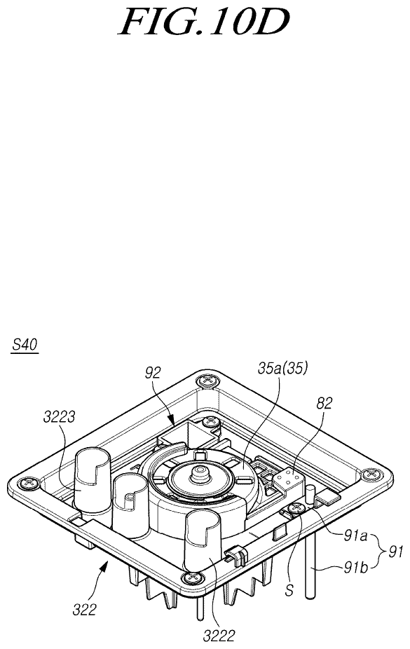

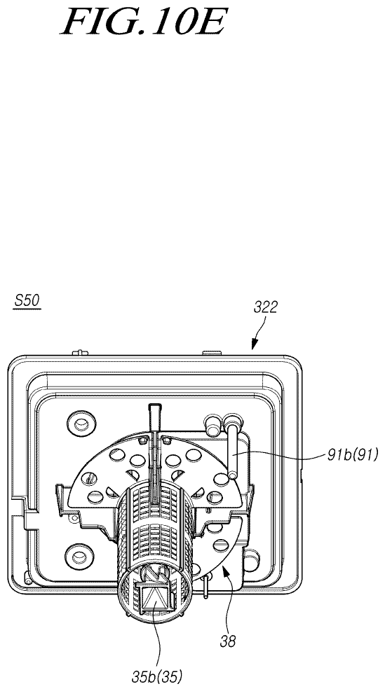

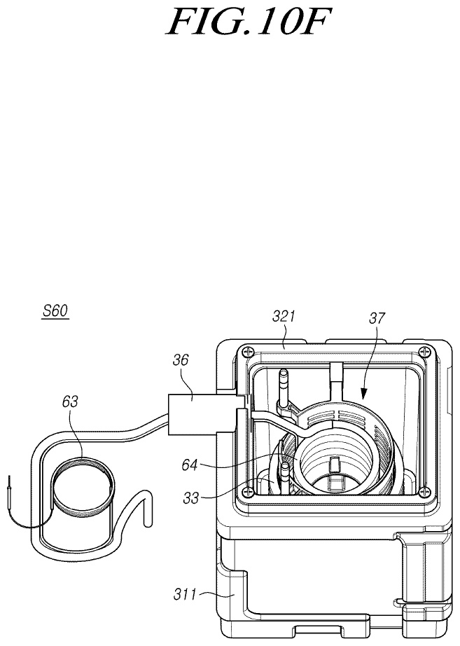

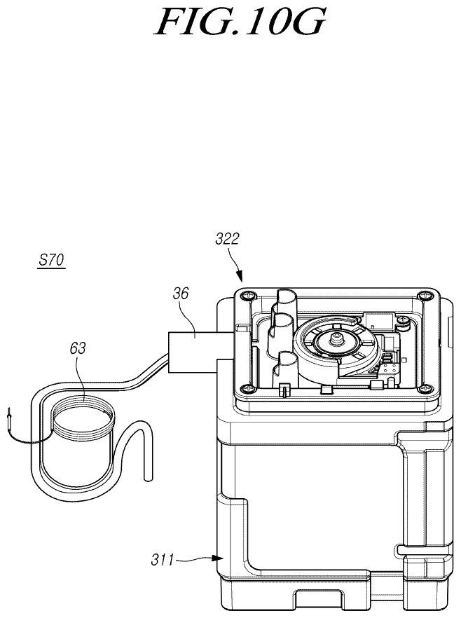

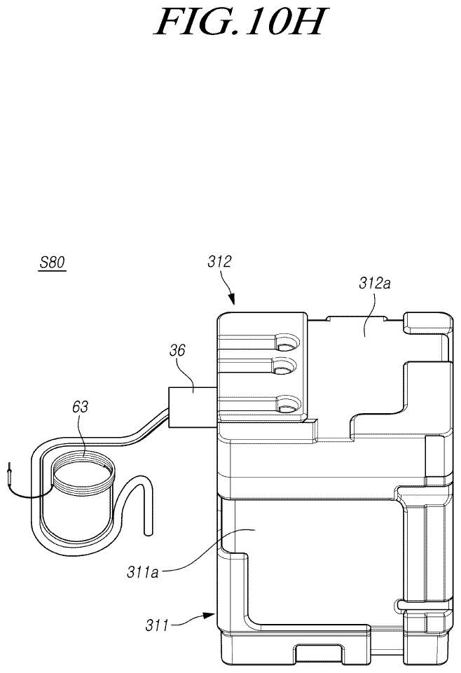

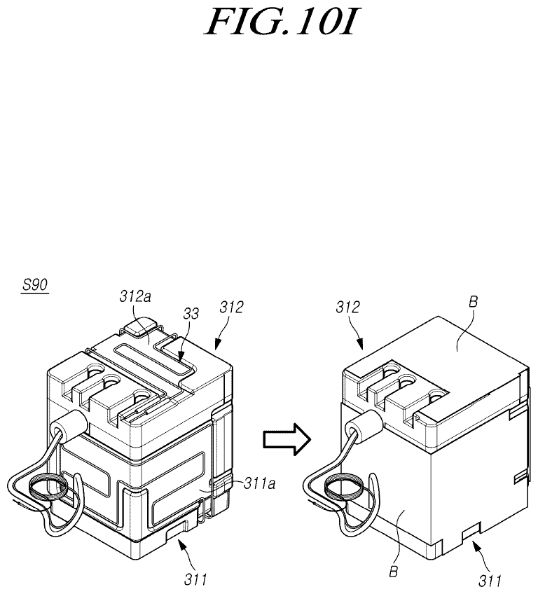

Referring to FIGS. 4 and 5, in an embodiment, the cooling device 30 may include an insulation cover 31, a water tank 32, a heater (e.g., the heater 33 of FIG. 10I), an evaporator 64 of the above-described cooling cycle device 60, a cold water pipe 34, a motor unit 35, an insulation member 36, a pipe bracket 37, and an ice guide 38.

According to an embodiment, the water tank 32 may include a water tank case 321 forming a lower exterior of the water tank 32 and a water tank cover 322 forming an upper exterior of the water tank 32. According to an embodiment, the water tank cover 322 may be coupled to the water tank case 321 above the water tank case 321. According to an embodiment, an opening (e.g., the opening 3211 of FIG. 10A) may be formed in the upper side of the water tank case 321. According to an embodiment, the water tank cover 322 may be coupled to the water tank case 321 to cover the opening 3211 of the water tank case 321. According to an embodiment, the water tank case 321 and the water tank cover 322 may be coupled to form the overall appearance of the water tank 32.

According to an embodiment, an ice storage liquid may be accommodated in the water tank case 321. According to an embodiment, inside the water tank case 321, the cold water pipe 34 through which water (e.g., purified water) supplied from the filter unit 20 flows, and at least some of components for cooling purified water flowing through the cold water pipe 34, e.g., at least a portion of the evaporator 64 forming a portion of the cooling cycle device 60, may be accommodated.

According to an embodiment, the cold water pipe 34 may form a flow path through which purified water introduced from the filter unit 20 flows. According to an embodiment, the purified water introduced into the cold water pipe 34 may be cooled through heat exchange with the ice storage liquid stored in the water tank 32 while flowing in the cold water pipe 34. According to an embodiment, the cold water pipe 34 may be disposed to form a spiral shape while occupying a large space in the water tank case 321 so that sufficient heat exchange with the ice storage liquid is performed.

According to an embodiment, as described above, at least a portion of the evaporator 64 may be disposed inside the water tank case 321. According to an embodiment, the evaporator 64 may be disposed to form a spiral shape so that sufficient heat exchange with the ice storage liquid is performed. According to an embodiment, the evaporator 64 may cool the ice storage liquid stored in the water tank 32 by evaporation of the refrigerant flowing through the evaporator 64. According to an embodiment, the evaporator 64 may be positioned further inside the water tank case 321 than the cold water pipe 34. According to an embodiment, the diameter of the spiral shape formed by the evaporator 64 may be set to be smaller than the diameter of the spiral shape formed by the cold water pipe 34, but the disclosure is not limited thereto.

According to an embodiment, the pipe bracket 37 may be disposed inside the water tank case 321. According to an embodiment, a guide groove (e.g., the guide groove 3214 of FIG. 10A) for guiding the pipe bracket 37 to be seated inside the water tank case 321 may be formed in an inner surface near the opening 3211 of the water tank case 321. According to an embodiment, the pipe bracket 37 may be fixed to the water tank case 321 through the guide groove (e.g., the guide groove 3214 of FIG. 10A). According to an embodiment, the guide groove 3214 may be recessed from the inner surface of the water tank case 321. According to an embodiment, the guide groove 3214 may extend in the vertical direction and may be provided to be open in one side (e.g., the upper side).

According to an embodiment, the pipe bracket 37 may support the cold water pipe 34 to be seated inside the water tank case 321. According to an embodiment, a guide rib 37a may be provided on the bottom surface of the pipe bracket 37 to guide the evaporator 64 to be seated on the pipe bracket 37. According to an embodiment, a plurality of guide ribs 37a may be provided. For example, each of the plurality of guide ribs 37a may be disposed to be spaced apart by 90 degrees (e.g., 12 o'clock, 3 o'clock, 6 o'clock, and 9 o'clock) when the water tank case 321 is viewed from above.

According to an embodiment, the pipe bracket 37 may be coupled to the cold water pipe 34. According to an embodiment, the pipe bracket 37 may include a pipe coupling portion 37b provided with a through hole (not shown) into which one end (e.g., the one end 34a of FIG. 10B) or the other end (e.g., the other end 34b of FIG. 10B) of the cold water pipe 34 is inserted.

According to an embodiment, a communication hole (e.g., the communication hole 3212 of FIG. 10A) may be formed in any one of the side surfaces of the water tank case 321 to allow at least a portion of the evaporator 64 to pass through and communicate between the inside and outside of the water tank 32. According to an embodiment, an insulation member 36 may be disposed in the communication hole 3212 to surround at least a portion of the evaporator 64 disposed to pass through the corresponding communication hole 3212.

According to an embodiment, a support rib 3213 may be formed on the bottom surface of the water tank case 321 to support the cold water pipe 34 to be seated inside the water tank case 321. According to an embodiment, a plurality of support ribs 3213 may be provided. For example, each of the plurality of support ribs 3213 may be disposed to be spaced apart by 90 degrees (e.g., 12 o'clock, 3 o'clock, 6 o'clock, and 9 o'clock) when the water tank case 321 is viewed from above. According to an embodiment, the support rib 3213 may protrude upward from the bottom surface of the water tank case 321.

According to an embodiment, at least some of the components for cooling purified water, e.g., the motor unit 35 and the ice guide 38, may be disposed on the water tank cover 322. According to an embodiment, a motor recess 3221 for mounting the motor 35a of the motor unit 35 may be formed in the upper surface of the water tank cover 322. According to an embodiment, the motor recess 3221 may be partially recessed downward from the upper surface of the water tank cover 322. According to an embodiment, the motor unit 35 may include a motor 35a disposed in the motor recess 3221, a motor sealing member 82 surrounding the motor 35a, and a stirrer 35b axially coupled to the motor 35a. According to an embodiment, the motor 35a may be mounted in the motor recess 3221 of the water tank cover 322. According to an embodiment, the motor sealing member 82 may seal the periphery of the motor 35a so that a gap toward the water tank case 321 does not occur around the motor 35a mounted in the motor recess 3221.

According to an embodiment, the stirrer 35b may be axially coupled to the motor 35a on the bottom side of the water tank cover 322 to extend into the lower water tank case 321, e.g., into the ice storage liquid accommodated in the water tank case 321. According to an embodiment, the motor 35a may provide rotational power to the stirrer 35b. According to an embodiment, as described above, the stirrer 35b may be axially coupled to the motor 35a to receive rotational power from the motor 35a.

According to an embodiment, the motor unit 35 may promote heat exchange between the ice storage liquid accommodated in the water tank case 321 and the purified water (or cold water) flowing inside the cold water pipe 34 or the refrigerant flowing inside the evaporator 64. For example, the motor unit 35 may promote heat exchange between the ice storage liquid and purified water in the cold water pipe 34 or heat exchange between the ice storage liquid and the refrigerant in the evaporator 64 by stirring and mixing the ice storage liquid in the water tank case 321 by the stirrer 35b rotated by the rotation of the motor 35a so that the temperature of the ice storage liquid becomes uniform.

According to an embodiment, the ice guide 38 may be coupled to the bottom surface of the water tank cover 322 to extend into the lower water tank case 321. According to an embodiment, the ice guide 38 may be positioned outside the stirrer 35b. According to an embodiment, the ice guide 38 may block ice (e.g., frost) falling off the surface of the evaporator 64 in the water tank case 321 from approaching the stirrer 35b. Accordingly, it is possible to prevent the stirrer 35b from colliding with the ice to reduce noise generated when the stirrer 35b rotates.

According to an embodiment, the insulation cover 31 may be provided to insulate the cooling device 30 from the outside. According to an embodiment, the insulation cover 31 may be disposed to surround the outer circumferential surface of the water tank 32, i.e., the outer circumferential surface of the water tank case 321 and the water tank cover 322 coupled thereto. According to an embodiment, the insulation cover 31 may be formed by foaming a foaming liquid outside the water tank 32. For example, the insulation cover 31 may be formed of polyurethane (PU). In this case, the insulation cover 31 may be referred to as a foamed PU foam.

According to an embodiment, the insulation cover 31 may include a water tank case insulator 311 disposed to surround the outer circumferential surface of the water tank case 321 and providing heat insulation. According to an embodiment, the insulation cover 31 may include a water tank cover insulator 312 that surrounds the outer circumferential surface of the water tank cover 322 and provides insulation. According to an embodiment, the water tank case insulator 311 and the water tank cover insulator 312 may be integrally formed not to be separated from each other.

According to an embodiment, the water tank case insulator 311 may be formed by a foaming process. According to an embodiment, the water tank case insulator 311 may be formed by foaming a foaming liquid outside the water tank case 321 of the water tank 32. According to an embodiment, the water tank case insulator 311 may be formed by foaming before the water tank cover insulator 312.

According to an embodiment, the water tank cover insulator 312 may be provided to surround, e.g., at least a portion (e.g., an upper portion of the water tank case insulator 311) of the water tank case insulator 311 in the foam-molded state and the water tank cover 322. According to an embodiment, the water tank cover insulator 312 may be formed by a foaming process. According to an embodiment, the water tank cover insulator 312 may be formed by foaming a foaming liquid to surround the water tank case insulator 311 and the outside of the water tank cover 322. According to an embodiment, e.g., after the water tank case insulator 311 is formed by first foaming on the water tank case 321, the water tank case 321 where the water tank case insulator 311 is formed and the water tank cover 322 coupled thereto are again foamed, forming a single whole insulation cover 31 including the water tank cover insulator 312 for the water tank cover 322. According to an embodiment, when the water tank case insulator 311 and the water tank cover insulator 312 are integrally foamed to form one insulator cover 31, a gap (or seam or gap) is not formed which may be formed otherwise when the insulator for the water tank case and the insulator for the water tank cover each are formed and then assembled, thereby effectively blocking cold air of the cooling device from leaking to the outside. Therefore, according to an embodiment, the water tank cover insulator 312 and a water tank case insulator 311 both are made of a foamed material and together form an integral insulator without a seam between the water tank cover insulator 312 and the water tank case insulator 311. Further, since there is no need for a separate sealing material for preventing a seam or gap that may occur between the insulator for the water tank case and the insulator for the water tank cover, the assembly process may be simplified.

According to an embodiment, the insulation cover 31 may be provided with heater guides 311a and 312a where a heater 33 is seated to prevent dew formation from occurring on the surface of the cooling device 30 due to a temperature difference between the inside and outside of the cooling device 30. According to an embodiment, the heater guides 311a and 312b may include a lower heater guide 311a or an upper heater guide 312a. According to an embodiment, the lower heater guide 311a may be formed by being recessed from at least one surface of the water tank case insulator 311. According to an embodiment, the upper heater guide 312a may be formed by being recessed from at least one surface of the water tank cover insulator 312. According to an embodiment, in the step of foaming the water tank case insulator 311 and/or the water tank cover insulator 312 to form the heater guides 311a and 312a, the foaming liquid may be avoided from the portion where the heater guides 311a and 312a are to be formed.

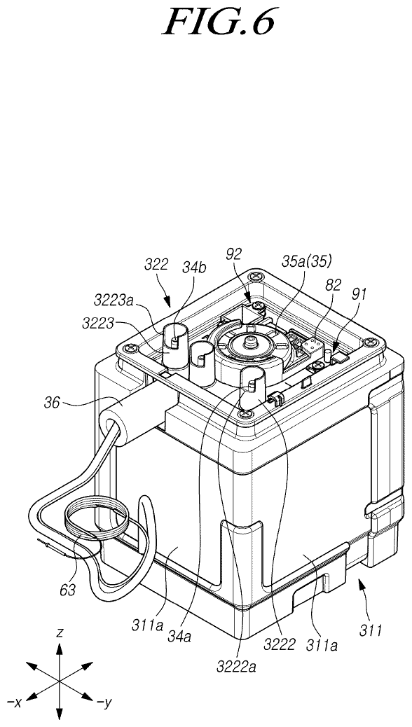

FIG. 6 is a perspective view illustrating a cooling device before a water tank cover insulator is foamed according to an embodiment of the disclosure.

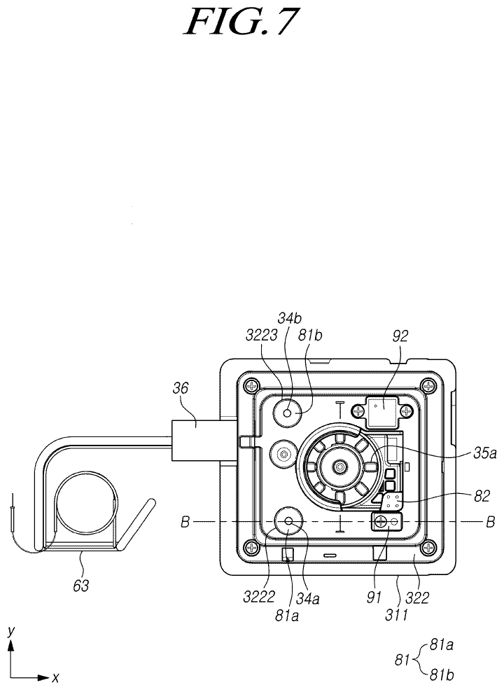

FIG. 7 is a plan view of the cooling device of FIG. 6.

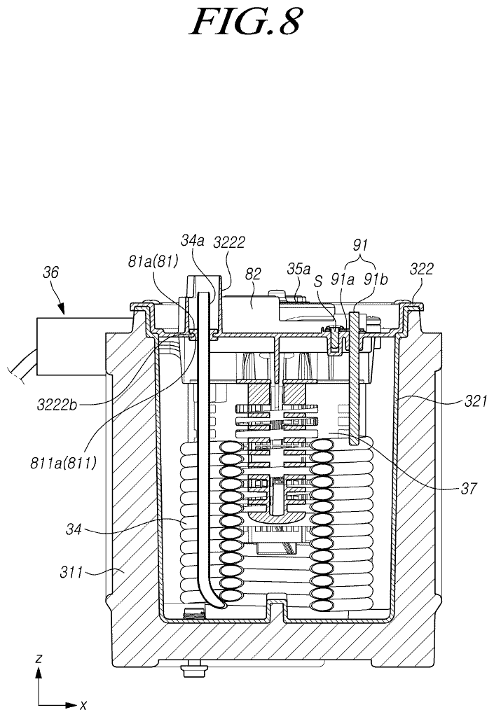

FIG. 8 is a cross-sectional view of the cooling device taken along line B-B of FIG. 7.

FIGS. 6 to 8 illustrate a state in which, according to an embodiment, the water tank case insulator 312 is foamed to surround the outside of the water tank case 321, and the water tank cover 322 is assembled and disposed on the water tank case 321, before the water tank cover insulator 312 is formed.

As illustrated, in an embodiment, communication pipes 3222 and 3223 may be formed on the water tank cover 322. According to an embodiment, the communication pipes 3222 and 3223 may include a first communication pipe 3222 and a second communication pipe 3223. According to an embodiment, each of the first communication pipe 3222 and the second communication pipe 3223 may extend upward (e.g., in the z direction) from the upper surface of the water tank cover 322. According to an embodiment, each of the first communication pipe 3222 and the second communication pipe 3223 may have a hollow shape in which the upper side and the lower side are open.

According to an embodiment, one end portion 34a (or a water inlet) of the cold water pipe 34 accommodated in the water tank 32 may extend to the outside of the water tank 32 through the first communication pipe 3222. According to an embodiment, the first communication pipe 3222 may include a first through portion 3222a recessed downward (e.g., in the −z direction) from a partial upper end portion of the first communication pipe 3222. According to an embodiment, the cold water pipe 34 that passes through the water tank cover 322 through the first communication pipe 3222 and extends vertically upward from the lower water tank case 321 may continuously extend in the horizontal direction (e.g., the −x direction) by changing the direction through the first through portion 3222a.

According to an embodiment, the first communication pipe 3222 may include a first coupling protrusion 3222b protruding radially inward from the inner circumferential surface of the first communication pipe 3222. According to an embodiment, the first pipe sealing member 81a may be fittingly coupled to the inside of the first communication pipe 3222. According to an embodiment, a coupling groove 811a for fittingly coupling with the first coupling protrusion 3222a of the inner circumferential surface of the first communication pipe 3222 may be provided in the outer circumferential surface of the first pipe sealing member 81a. According to an embodiment, the first pipe sealing member 81a may be disposed to surround the cold water pipe 34 passing through the first communication pipe 3222. According to an embodiment, the first pipe sealing member 81a may have an annular (e.g., donut) shape as a whole. According to an embodiment, the first pipe sealing member 81a may be formed of a rubber material. According to an embodiment, the inner circumferential surface of the first pipe sealing member 81a may contact the cold water pipe 34, and the outer circumferential surface of the first pipe sealing member 81a may contact the first communication pipe 3222.

According to an embodiment, the other end portion 34b (or the cold water discharge portion) of the cold water pipe 34 accommodated in the water tank 32 may extend to the outside of the water tank 32 through the second communication pipe 3223. According to an embodiment, the second communication pipe 3223 may include a second through portion 3223a recessed downward (e.g., in the −z direction) from a partial upper end portion of the second communication pipe 3223. According to an embodiment, the cold water pipe 34 that passes through the water tank cover 322 through the second communication pipe 3223 and extends vertically upward from the lower water tank case 321 may continuously extend in the horizontal direction (e.g., the −x direction) by changing the direction through the second through portion 3223a.

According to an embodiment, the second communication pipe 3223, like the first communication pipe 3222a described above, may include a second coupling protrusion (not shown) radially protruding inward from the inner circumferential surface. According to an embodiment, the second pipe sealing member 81b may be fittingly coupled to surround the second communication pipe 3223, like the first pipe sealing member 81a fittingly coupled to surround the first communication pipe 3222. According to an embodiment, on the outer circumferential surface of the second pipe sealing member 81b, a coupling groove (not shown) for fittingly coupling with the second coupling protrusion (not shown) on the inner circumferential surface of the second communication pipe 3223 may be provided. According to an embodiment, the second pipe sealing member 81b may be disposed to surround the cold water pipe 34 passing through the second communication pipe 3223. According to an embodiment, the second pipe sealing member 81b may have an annular (e.g., donut) shape as a whole. According to an embodiment, the second pipe sealing member 81b may be formed of a rubber material. According to an embodiment, an inner circumferential surface of the second pipe sealing member 81b may contact the cold water pipe 34, and an outer circumferential surface of the second pipe sealing member 81b may contact the second communication pipe 3223.

According to an embodiment, the first pipe sealing member 81a and the second pipe sealing member 81b may seal around the cold water pipe 34 extending through the first communication pipe 3222 and the second communication pipe 3223, respectively, to prevent a gap open into the lower water tank case 321. According to an embodiment, the first pipe sealing member 81a and the second pipe sealing member 81b may prevent the foam liquid overflowing into the first and second communication pipes 3222 and 3223 from flowing into the water tank case 321 during the foaming process for the water tank cover insulator 312.

According to an embodiment, as described above with reference to FIGS. 4 and 5, the motor 35a may be mounted on the upper surface of the water tank cover 322, and the motor sealing member 82 may be disposed to surround the motor 35a. According to an embodiment, the motor sealing member 82 may be mounted in a motor recess (e.g., the motor recess 3221 of FIG. 5) of the water tank cover 322, and may seal a peripheral gap surrounding the motor 35a. According to an embodiment, the motor sealing member 82 may be provided to surround at least a portion of the motor 35a. According to an embodiment, the motor sealing member 82 may be formed of a rubber material. The motor sealing member 82 may prevent the foaming liquid from flowing into the water tank case 321 along the gap around the motor 35a or the shaft of the motor 35a in the foaming process for the water tank cover insulator 312.

According to an embodiment, a temperature sensor 91 may be disposed on the water tank cover 322. According to an embodiment, the temperature sensor 91 may include a fastening plate 91a and a temperature detector 91b. According to an embodiment, the fastening plate 91a and the temperature detector 91b may be integrally provided. According to an embodiment, the temperature detector 91b of the temperature sensor 91 may extend from the water tank cover 322 toward the lower water tank case 321 to detect the temperature of the water (e.g., ice storage liquid) accommodated in the water tank case 321. According to an embodiment, the temperature sensor 91 may be a thermal sensitive resistor-type temperature sensor, but is not limited thereto. According to an embodiment, the fastening plate 91a of the temperature sensor 91 may be screwed S to the upper surface of the water tank cover 322, and in such a case, a gap communicating toward the lower water tank case 321 may be prevented from being formed around the temperature sensor 91.

According to an embodiment, a water level sensor 92 may be disposed on the water tank cover 322. According to an embodiment, the water level sensor 92 may detect the full water level of the water (or ice storage liquid) accommodated in the water tank case 321. According to an embodiment, the water level sensor 92 may be a capacitive level type water level sensor, but is not limited thereto.

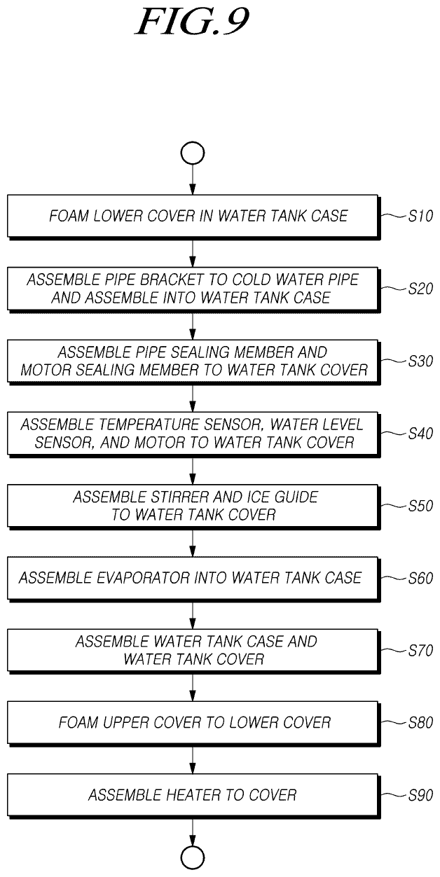

FIG. 9 is a flowchart illustrating an order of assembly of a cooling device according to an embodiment of the disclosure.

FIGS. 10A to 10I are views illustrating an assembly process of a cooling device according to an embodiment of the disclosure.

Hereinafter, a method for manufacturing a cooling device 30 according to an embodiment of the disclosure is described with reference to FIGS. 9 to 10I.

According to an embodiment, first, in process S10, the water tank case insulator 311 may be foamed outside the water tank case 321. For example, as the water tank case 321 is seated on the foam jig and the foaming liquid is foamed on the outside of the water tank case 321, the water tank case insulator 311 surrounding the water tank case 321 may be formed (see FIG. 10A). The foam jig used for forming the water tank case insulator 311 in step S10 may be configured to allow the foaming liquid to be avoided so that the above-described heater guide 311a is provided on the water tank case insulator 311.

According to an embodiment, in process S20, the pipe bracket 37 and the cold water pipe 34 may be assembled inside the water tank case 321. According to an embodiment, e.g., after the cold water pipe 34 is first assembled to the pipe bracket 37, the pipe bracket 37 and the cold water pipe 34 in the assembled state may be together assembled to the water tank case 321 through the support rib 3213 and the guide groove 3214 disposed in the water tank case 321 (see FIG. 10B), but the disclosure is not limited thereto.

According to an embodiment, in process S30, the sealing members 81 and 82 may be disposed at the positions where each component has been disposed or is to be disposed. For example, the first and second pipe sealing members 81a and 81b may be disposed to be fittingly coupled to the first and second communication pipes 3222 and 3223 of the water tank cover 322, in which the end portions thereof are disposed to be penetrated. For example, the motor sealing member 82 may be disposed at a position in the motor recess 3221 of the water tank cover 322 where the motor 35a is to be mounted (see FIG. 10C).

According to an embodiment, in process S40, each component, e.g., the motor 35a, the temperature sensor 91, and the water level sensor 92, may be assembled at predetermined positions of the water tank cover 322. For example, the motor 35a may be fittingly coupled to the motor sealing member 82 mounted on the water tank cover 322 (see FIG. 10D). For example, the temperature sensor 91 and/or the water level sensor 92 may be disposed at a predetermined position on the water tank cover 322, and may be coupled to the water tank cover 322 through a fastening member (e.g., a screw S) (see FIG. 10D).

According to an embodiment, in process S50, the stirrer 35b and the ice guide 38 each may be assembled to the water tank cover 322. For example, the stirrer 35b may be assembled to the water tank cover 322 through axial coupling with the motor 35a mounted on the upper surface of the water tank cover 322 in a direction facing the bottom surface of the water tank cover 322 (see FIG. 10E). For example, the ice guide 38 may be coupled to the bottom surface of the water tank cover 322 to surround the stirrer 35b (see FIG. 10E).

According to an embodiment, in process S60, the evaporator 64 may be assembled inside the water tank case 321. For example, the evaporator 64 may be seated inside the water tank case 321 by the guide rib 37a of the pipe bracket 37 (see FIG. 10F). For example, a portion of the evaporator 64 extending outside the water tank 32 and the insulation member 36 surrounding the evaporator 64 may be coupled to the communication hole 3212 of the water tank case 321 (see FIG. 10F).

According to an embodiment, in process S70, the water tank cover 322 may be disposed and assembled on the water tank case 321. For example, the water tank cover 322 may be coupled to the water tank case 321 to shield the opening 3211 of the water tank case 321 (see FIG. 10G).

According to an embodiment, in process S80, the water tank cover insulator 312 may be foamed outside the water tank cover 322. According to an embodiment, after the water tank cover 322 disposed above together with the lower water tank case insulator 311 is seated on the foam jig, the foaming liquid is foamed to form the water tank cover insulator 312 surrounding the water tank cover 322 (see FIG. 10H). According to an embodiment, the lower water tank case insulator 311 and the upper water tank cover insulator 312 may be integrally foamed to form an integral insulation cover 31.

According to an embodiment, in process S90, the heater 33 may be disposed on the insulation cover 31. For example, the heater 33 may be disposed on the heater guides 311a and 312a provided on the insulation cover 31 to surround the insulation cover 31. Thereafter, a fixing member (e.g., an aluminum tape B) for fixing the heater 33 to the insulation cover 31 may be attached to the insulation cover 31 to surround the heater guides 311a and 312a (e.g., FIG. 10I). According to an embodiment, the heater 33 may correspond to a heating cable, but is not limited thereto.

Referring to FIGS. 9 to 10I, the above-described cooling device assembly process flow is merely an example, but the disclosure is not limited thereto. According to embodiments of the disclosure, the order of assembling each component of the cooling device may be variously modified.

The terms as used herein are provided merely to describe some embodiments thereof, but are not intended to limit the disclosure. As used herein, the singular forms “a,” “an,” and “the” are intended to include the plural forms as well, unless the context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, the term ‘and/or’ should be understood as encompassing any and all possible combinations by one or more of the enumerated items. As used herein, the terms “include,” “have,” and “comprise” are used merely to designate the presence of the feature, component, part, or a combination thereof described herein, but use of the term does not exclude the likelihood of presence or adding one or more other features, components, parts, or combinations thereof. As used herein, the terms “first” and “second” may modify various components regardless of importance and/or order and are used to distinguish a component from another without limiting the components.

As used herein, the terms “configured to” may be interchangeably used with the terms “suitable for,” “having the capacity to,” “designed to,” “adapted to,” “made to,” or “capable of” depending on circumstances. The term “configured to” does not essentially mean “specifically designed in hardware to.” Rather, the term “configured to” may mean that a device can perform an operation together with another device or parts. For example, a ‘device configured (or set) to perform A, B, and C’ may be a dedicated device to perform the corresponding operation or may mean a general-purpose device capable of various operations including the corresponding operation.

Meanwhile, the terms “upper side”, “lower side”, and “front and rear directions” used in the disclosure are defined with respect to the drawings, and the shape and position of each component are not limited by these terms.

In the disclosure, the above-described description has been made mainly of specific embodiments, but the disclosure is not limited to such specific embodiments, but should rather be appreciated as covering all various modifications, equivalents, and/or substitutes of various embodiments.

What is claimed is:

1. A cooling device for a water purifier, comprising:
a water tank case to accommodate cooling water therein;
an evaporator at least partially accommodated in the water tank case to exchange heat with the cooling water accommodated in the water tank case;
a water tank cover having at least one component disposed thereon and disposed above the water tank case;
a water tank cover insulator and a water tank case insulator that are both made of a foamed material and together form an integral insulator without a seam between the water tank cover insulator and the water tank case insulator, wherein the water tank case insulator surrounds an outer circumferential surface of the water tank case, and the water tank cover insulator surrounds an outer circumferential surface of the water tank cover; and
a sealing member disposed to prevent a gap leading to the water tank case from being formed, around the at least one component disposed on the water tank cover.

2. The cooling device of claim 1, further comprising:
a cold water pipe at least partially accommodated in the water tank case, and having an inside where water for heat exchange with the cooling water accommodated in the water tank case flows,
wherein the at least one component disposed on the water tank cover includes a portion of the cold water pipe passing through the water tank cover and communicating with an outside of the cooling device, and
wherein the sealing member includes a cold water pipe sealing member disposed not to form the gap leading to the water tank case around the portion of the cold water pipe.

3. The cooling device of claim 2, wherein:
the water tank cover includes a pair of communication pipes having a hollow shape extending upward from an upper surface of the water tank cover,
the cold water pipe passes through each of the pair of communication pipes, and
the cold water pipe sealing member seals a space between each communication pipe and a cold water pipe passing through a corresponding communication pipe.

4. The cooling device of claim 1, wherein
the at least one component disposed on the water tank cover includes a stirring motor to stir the cooling water accommodated in the water tank case, and
the sealing member includes a motor sealing member disposed not to form a gap leading to the water tank case around the stirring motor.

5. The cooling device of claim 4, wherein
the water tank cover includes a motor recess recessed downward from an upper surface of the water tank cover, and
the motor sealing member is disposed in the motor recess.

6. The cooling device of claim 1, further comprising:
a heater disposed on a surface of the water tank cover insulator or the water tank case insulator to prevent dew formation on a surface of the cooling device,
wherein the water tank cover insulator or the water tank case insulator includes a heater guide in which at least a portion of a surface thereof is recessed to allow the heat to be seated therein.

7. The cooling device of claim 1, wherein
the at least one component disposed on the water tank cover includes a temperature sensor for measuring a temperature inside the water tank case, and
the cooling device further comprises a fastening plate and a screw fastening structure for sealing the temperature sensor and which are disposed above the temperature sensor.

8. A method comprising:
foaming a water tank case insulator surrounding an outer circumferential surface of a water tank case configured to accommodate cooling water;
disposing one or more structure for supplying cold water into the water tank case;
disposing a sealing member at at least one position on a water tank cover configured to cover an upper portion of the water tank case;
disposing a component corresponding to the at least one position of the water tank cover;
disposing the water tank cover to cover an upper side of the water tank case; and
integrally foaming an insulator to surround the water tank case and the water tank cover disposed on the upper side of the water tank case.

9. The method of claim 8,
wherein the one or more structures for supplying the cold water, disposed in the water tank case includes an evaporator and a cold water pipe where water cooled by heat exchange with the evaporator flows,
wherein disposing the component corresponding to the at least one position of the water tank cover includes disposing to allow a portion of the cold water pipe to pass through the water tank cover and communicate with an outside of the water tank case, and
wherein disposing the sealing member includes disposing a cold water pipe sealing member around the portion of the cold water pipe.

10. The method of claim 9,
wherein the water tank cover includes a pair of communication pipes having a hollow shape extending upward from an upper surface of the water tank cover,
wherein disposing to allow the portion of the cold water pipe to pass through the water tank cover and communicate with the outside of the water tank case includes disposing the cold water pipe to pass through each of the pair of communication pipes, and
wherein disposing the cold water pipe sealing member includes disposing the cold water pipe sealing member to seal a space between each communication pipe and a cold water pipe passing through a cooling device communication pipe.

11. The method of claim 8,
wherein disposing the component corresponding to the at least one position of the water tank cover includes disposing a stirring motor stirring the cooling water accommodated in the water tank case, and
wherein disposing the sealing member includes disposing a motor sealing member around the stirring motor.

12. The method of claim 11, wherein
the water tank cover includes a motor recess recessed downward from an upper surface, and
the motor sealing member is disposed in the motor recess.

13. The method of claim 8,
wherein disposing the component corresponding to the at least one position of the water tank cover includes disposing a temperature sensor, and
wherein disposing the sealing member includes disposing a fastening plate and a screw fastening structure for sealing the temperature sensor, above the temperature sensor.

14. The method of claim 8, wherein integrally foaming the insulator to surround the water tank case and the water tank cover includes foaming the insulator to form a recess for disposing a heating cable in an outer circumferential surface of the insulator.

15. A water purifier, comprising:
a filter unit to generate purified water by filtering raw water; and
a cooling device to generate cold water by cooling the purified water generated by the filter unit, wherein the cooling device includes:
a water tank case to accommodate cooling water therein,
an evaporator at least partially accommodated in the water tank case to exchange heat with the cooling water accommodated in the water tank case,
a water tank cover having at least one component disposed thereon and disposed above the water tank case,
a water tank cover insulator and a water tank case insulator that are both made of a foamed material and together form an integral insulator without a seam between the water tank cover and the water tank case insulator, wherein the water tank case insulator surrounds an outer circumferential surface of the water tank case, and the water tank cover insulator surrounds an outer circumferential surface of the water tank cover, and
a sealing member disposed to prevent a gap leading to the water tank case from being formed, around the at least one component disposed on the water tank cover.
